(19) United States
(12) Patent Application Publication
(10) Pub. No.: US 2004/0076792 A1
(43) Pub. Date: Apr. 22, 2004

(54) Topically applied antimicrobial carpet treatment

(76) Inventors: David E. Green, Simpsonville, SC (US); Elizabeth S. Cribbs, Inman, SC (US); Leland G. Close, Spartanburg, SC (US); Howard D. Childress, Spartanburg, SC (US); William S. Parks, Boiling Springs, SC (US)

Correspondence Address: Milliken & Company, P.O. Box 1927, Spartanburg, SC, 29304, US

(21) Appl. No.: 10/277,378

(22) Filed: Oct. 22, 2002

(51) Int. Cl. B32B 3/02; B32B 33/00; D06M 10/00

(52) U.S. Cl. 428/96; 252/8.61

(57) ABSTRACT

Topical antimicrobial floor covering treatments comprising solid antimicrobial particles that become embedded within target fibers to impart a durable antimicrobial finish are provided. Such a topical treatment includes specific inorganic antimicrobial metal ion-based solid compounds, such as silver ion-exchange compounds, silver zeolites, and/or silver glasses, which is present within a liquid medium or mixed with another solid treatment agent. Such treatments also optionally include compositions of stain resistant agents, anti soil-redeposition compounds and liquids, surfactants, antistatic agents, and the like, to impart other characteristics to the target carpeted products. Such carpet treatments thus impart excellent antimicrobial characteristics at both the surface of the carpet pile, as well as within the pile itself. Furthermore, it has been found that application of such solid metal-ion based antimicrobials permits the ability to increase antimicrobial activity for the target carpet product after vacuuming and/or durability after further shampooing.

### FIELD OF THE INVENTION

This invention relates to topical antimicrobial floor covering treatments comprising solid antimicrobial particles that become embedded within target fibers to impart a durable antimicrobial finish. Such a topical treatment includes specific inorganic antimicrobial metal ion-based solid compounds, such as silver ion-exchange compounds, (including silver zirconium phosphates, silver zeolites, and/or silver glasses, for example), which is present within a liquid medium or mixed with another solid treatment agent. Such treatments also optionally include compositions of stain resistant agents, anti soil-redeposition compounds and liquids, surfactants, antistatic agents, and the like, to impart other characteristics to the target carpeted products. Such carpet treatments thus impart excellent antimicrobial characteristics at both the surface of the carpet pile, as well as within the pile itself. Furthermore, it has been found that application of such solid metal-ion based antimicrobials permits the ability to increase antimicrobial activity for the target carpet product after vacuuming and/or durability after further shampooing.

### DISCUSSION OF THE PRIOR ART

All U.S. patents listed below are herein entirely incorporated by reference.

There has been a great deal of attention in recent years given to the hazards of bacterial contamination from potential everyday exposure. Noteworthy examples of such concern include the fatal consequences of food poisoning due to certain strains of Eschericia coli being found within undercooked beef in fast food restaurants; Salmonella contamination causing sicknesses from undercooked and unwashed poultry food products; and illnesses and skin infections attributed to Staphylococcus aureus, Klebsiella pneumoniae, yeast, and other unicellular organisms. With such an increased consumer interest in this area, manufacturers have begun introducing antimicrobial agents within various household products and articles. For instance, certain brands of polypropylene cutting boards, liquid soaps, etc., all contain antimicrobial compounds. The most popular antimicrobial for such articles is triclosan. Although the incorporation of such a compound within liquid or certain polymeric media has been relatively simple, other substrates, including the surfaces of textiles and fibers, have proven less accessible. Furthermore, triclosan includes chlorine ions which, upon dissociation, may release to the substrate surface. Such ions are potentially hazardous to humans, due to skin irritation upon contact, as well as within environmental effluents, and the like. Additionally, harmful microbes have shown, on occasion, an ability to develop an immunity to the bactericidal properties of triclosan. Also, surface treatments with triclosan have proven ineffective as well since such compounds are highly water soluble and are easily removed upon exposure to sufficient amounts of moisture.

Carpets, particularly the pile portion of carpets (e.g., the portion which is designed to be in contact with pedestrians' footwear, such as tufted fibers, cut pile, loop pile, and the like), is highly susceptible to bacteria, fungi, and other types of microorganism contamination. With pedestrians walking on such surfaces with footwear, bare feet, and the like, not to mention the likelihood of liquid spills, crumbs, and other bacterial and fungal nutrients being relatively high, the transfer of bacteria and fungi, not to mention the facilitation of sustenance and growth of such microorganisms, are likely as well. Certain cleaning methods, such as steam cleaning, seem to increase the growth rate over time of such microorganisms as well by leaving an aqueous environment within the carpet surface portion for nutrient growth and thus subsequent microorganism sustenance and growth. Although the bacteria or fungi may be hindered by high temperature exposure during such cleaning, once the temperature level returns to normal, such microorganisms can return from dormancy. Antimicrobials have been applied to carpet backings to prevent adhesive failure and thus delamination of the pile portion from the backing itself. Furthermore, some antimicrobial application to carpet pile portions have occurred as well, including U.S. Pat. No. 5,096,747 to Scholla et al., that discloses a carpet to which a simultaneous treatment of stain resist and antibacterial compounds has been applied. However, patentees disclose anionic and/or nonionic types of antimicrobials, such as, preferably, glutaraldehyde, Microban X-580 (isopropanol, p-di-iso-butylphenoxyethoxy-bromine complex, and n-octyl-bi-cycloheptane-di-carboxyimide, piperonylbutoxide, and pyrethrin), and phosphoric acid; there is no mention anywhere within this patent of metal-based, let alone metal-ion based inorganic antimicrobials. Such prior art antimicrobials appear to exhibit deficiencies, such as lack of long-term efficacy (and thus requirement of repeated treatments for continued high antimicrobial performance levels), and potential bacterial immunity. Also, U.S. Pat. No. 5,503,840 discloses the utilization of coated barium sulfate particles (with silver, copper, alumina, silica, and diocyl azelate) for utilization as an antimicrobial within carpet fibers and yams, not as a topical application thereon. There thus remains a long-felt need to provide a short- and long-term effective, durable, and long-lasting topically applied antimicrobial agent for carpet pile surfaces and products.

Specific metal ion-containing (such as Ag⁺-containing, for example) inorganic microbiocides (e.g., ion-exchange compounds, such as zirconium phosphates, glass, and/or zeolite compounds) have recently been developed and utilized as antimicrobial agents on and within a plethora of different substrates and surfaces. These types of antimicrobials are highly desirable because of their ability to provide efficacy in antimicrobial activity, without fear of bacterial or fungal immunity thereto, not to mention the lack of highly oxidative moieties and pendant groups (such as chlorine-based compounds) that can provide harmful irritation and potentially unpleasant smells, as well as the ease in handling of such solid particulates in general, create a desire to employ such compounds within many different media. In particular, such microbiocides have been adapted for incorporation within plastic compositions and fibers in order to provide household and consumer products which inherently exhibit antimicrobial characteristics. Although such silver-based agents provide excellent, durable, antimicrobial properties, to date no teachings exist which teach or fairly suggest the presence of such inorganic compounds as durable topical applications on carpet pile fibers. This is not surprising considering the difficulties in providing a durable topical application of solid particles on any surface, let alone specific carpet pile surfaces and fibers. The propensity of such solid particulates to gravitate to the bottom of such carpet pile structures, and thus seemingly fail to provide effective antimicrobial performance throughout such fibers (i.e., at the top portion, at the middle portion, and at the bottom portion, simulatneously) has militated against attempting such a treatment. This nonuniformity in protection thus requires amelioration prior to effective utilization of such highly desired antimicrobial agents. To date, such an obstacle has not been overcome to permit widespread utilization of such antimicrobials within carpet pile structures.

### DESCRIPTION OF THE INVENTION

It is thus an object of the invention to provide a simple manner of effectively treating a carpet pile portion of a floor covering article with a durable antimicrobial metal-ion containing antimicrobial treatment in a cleaning or post-cleaning procedure. Another object of the invention is to provide a simple manner of effectively treating a carpet pile portion of a floor covering article with a durable antimicrobial metal-ion containing antimicrobial treatment that also imparts antifungal and odor-reduction characteristics thereto.

Accordingly, this invention encompasses a method of topically applying an antimicrobial treatment to a floor covering article comprising the steps of

(a) providing a solid or liquid treatment composition comprising a solid antimicrobial and at least one other compound selected from the group consisting of a surfactant, aurea-formaldehyde-containing powder, fumed silica, and any mixture thereof;

(b) providing a floor covering article; and

(c) contacting said treatment composition of step “a” with said floor covering article of step “b”;

wherein said treatment composition imparts an antimicrobial level to said floor covering article measured as a log kill rate for Klebsiella pneumoniae of at least 1.0, preferably above 1.5, more preferably above 2.0, as tested in accordance with AATCC Test Method 100-1999 for 24 hour exposure, after at least 2 standard carpet shampoo treatments in accordance with AATCC Test Method 138. Such an invention also encompasses the different treatment compositions within the method described above. The shampoo durability test noted above is standard and, as will be well appreciated by one of ordinary skill in this art, is not intended to be a required or limitation within this invention. Such a test method merely provides a standard which, upon 2 shampoos in accordance with such, the inventive treated carpeted floor covering article will not lose an excessive level of its antimicrobial efficacy.

The effective amount of solid antimicrobial retained by the treated floor covering article may be measured in any standard manner, such as, for example, inductively coupled plasma (ICP), X-ray fluorescence (XRF), or atomic absorption (AA) spectroscopic analysis. However, again, in the alternative, the durability of such topically applied carpet treatments are preferably determined (i.e., the retention of treatment on the carpet pile surface) in relation to antimicrobial performance. Thus, with an antimicrobially effective treatment, the exhibition of log kill rate for Klebsiella pneumoniae after 24 hours exposure in accordance with AATCC Test Method 100-1999 of at least 1.0, higher, as noted above, after 2 shampoos in accordance with AATCC Test Method 138 is indication of the proper and necessary amount of solid antimicrobial retained and/or still antimicrobially effective for minimum acceptable performance. Preferably, these log kill rates are above 1.2, more preferably 1.5, and most preferably at least 2.0. such log kill rates after the minimum number of shampoos symbolizes the desired durability level noted above.

Nowhere within the prior art has such a specific treated carpeted floor covering or method of making thereof been disclosed, utilized, or fairly suggested. The closest art, Scholla et al., noted above, names certain liquid antimicrobials as potential co-additives to carpet pile structures simultaneously with certain stain-resist finishes. No solid antimicrobial, let alone metal-ion containing solid antimicrobial, let alone silver-ion containing antimicrobial compounds are taught nor fairly suggested. All other prior art discusses the extrusion of solid antimicrobials within fibers, which may include carpet fibers, to impart antimicrobial characteristics to the target floor covering article. However, nowhere has such a durable topical treatment as described broadly above been mentioned or alluded to.

Any standard carpet yarn or fiber may be utilized as the substrate for topoical treatment thereof within this application. Thus, natural (cotton, wool, and the like) or synthetic fibers (polyesters, polyamides, polyolefins, and the like) may constitute the target substrate, either by itself or in any combinations or mixtures of synthetics, naturals, or blends or both types. As for the synthetic types, for instance, and without intending any limitations therein, polyolefins, such as polyethylene, polypropylene, and polybutylene, halogenated polymers, such as polyvinyl chloride, polyesters, such as polyethylene terephthalate, polyester/polyethers, polyamides, such as nylon 6 and nylon 6,6, polyurethanes, as well as homopolymers, copolymers, or terpolymers in any combination of such monomers, and the like, may be utilized within this invention. Nylon-6, nylon-6,6, polypropylene, and polyethylene terephthalate (a polyester) are particularly preferred. Additionally, the target fibers may include additives coextruded therein, may be precoated with any number of different materials, including those listed in greater detail below, and/or may be dyed or colored to provide other aesthetic features for the end user with any type of colorant, such as, for example, poly(oxyalkylenated) colorants, as well as pigments, dyes, tints, and the like. Other additives may also be present on and/or within the target fiber or yam, including antistatic agents, brightening compounds, nucleating agents, antioxidants, UV stabilizers, fillers, permanent press finishes, softeners, lubricants, curing accelerators, and the like. Particularly desired as optional and supplemental finishes to the inventive fabrics are soil release or anti-redeposition agents which improve the hydrophobicity and cleanability of the carpet pile yams and fibers (such as SCOTCHGUARD, for example). Additionally, other potential additives and/or finishes may include water repellent fluorocarbons and their derivatives, silicones, waxes, and other similar water-proofing materials, antistatic agents, binding agents, and the like.

The particular treatment preferably comprises at least one type of solid metal-ion containing particles, or mixtures thereof. The term metal is intended to include any such historically understood member of the periodic chart (including transition metals, such as, without limitation, silver, zinc, copper, nickel, iron, magnesium, manganese, vanadium, gold, cobalt, platinum, and the like, as well as other types including, without limitation, aluminum, tin, calcium, magnesium, antimony, bismuth, and the like). More preferably, the metals utilized within this invention are generally those known as the transition metals. Of the transition metals, the more preferred metals are silver, zinc, gold, copper, nickel, manganese, and iron. Most preferred are silver and zinc. Such metals provide the best overall desired characteristics, such as, preferably, antimicrobial, antifungal, and/or odor reducing characteristics, certain colorations, good lightfastness, and, most importantly, shampoo durability on the target carpet pile substrate.

The preferred metal-ion containing compound for this invention is an antimicrobial silver zirconium phosphate available from Milliken & Company, under the tradename ALPHASAN®, although any silver-containing antimicrobial compound, including, for instance, and as merely some examples, a silver-substituted zeolite available from Sinanen under the tradename ZEOMIC®, or a silver-substituted glass available from Ishizuka Glass under the tradename IONPURE®, may be utilized either in addition to or as a substitute for the preferred species. Also preferred as such a compound is zinc oxide, zinc ricinoleate, zinc chloride, and zinc sulfate. Other metals, as noted above, may also be utilized; however, from a performance standpoint, silver and zinc, are preferred; however, silver ion-containing types are most preferred. Generally, such a metal compound is added in an amount of from about 0.01 to 60% by total weight of the particular treatment composition; more preferably from about 0.05 to about 50%; and most preferably from about 0.1 to about 50% (depending on the target use; with liquids, the amount is very low due to ability to deliver sufficient amounts of antimicrobial during liquid treatments, whereas the amounts within solid mixes are rather large due to lower amounts of solid being contacted with target pile surfaces; thus, with solid topical applications, relatively high amounts of antimicrobial within the initial mix delivers sufficient antmicrobial levels during use). Therefore, the metal-ion containing compound is added, as an active, to the target substrate via delivery from either a liquid (shampoo, for example) or solid medium, in amounts of between 100 and 15000 ppm on the weight of the face fiber (owff), more preferably from between 150 to about 14000 ppm, still more preferably from 175 to 13000 ppm, and most preferably between 200 and 12000 ppm (which translates into roughly 0.02 to 1.2% by weight owff). Such proportions provide the best antimicrobial and/or odor-reducing performance in relation to wash durability, electrical non-conductivity, and overall cost, not to mention the best potential for sufficient amounts to remain embedded within the target fibers after further and/or future vacuum or other cleaning procedures are undertaken. The treatment itself, including any necessary binders, adherents, thickeners, and the like, is added to the substrate in an amount of a) about 0.01 to about 8.0 ounces per square yard, or b) from about 0.1 to about 20% owff. Other possible compounds, again without limitation, are silver-based materials such as AMP® T558 and MICROFREE®, both available from DuPont, as well as JMAC®, available from Johnson Mathey.

If the treatment composition is a liquid, the solid antimicrobial may either be suspended, dispersed, or merely present within a liquid medium including a surfactant. The liquid medium should be relatively volatile in nature in order to facilitate evaporation upon contact with the target floor covering article. Thus, the liquid medium (or vehicle) may be selected from water, a short-chain alcohol (e.g., methanol, ethanol, isopropanol, butanol, as examples), etc. The surfactant may be selected from the general classes of cationic, anionic, amphoteric, nonionic, zwitterionic, and any mixtures thereof Such a surfactant is utilized to aid in permitting effective contact between the solid antimicrobial and the fibers of the target floor covering article in order, it is believed, and without intending to be limited to any scientific theory, to facilitate embedding of the solid antimicrobial compounds within the target fibers for durability purposes. Although any type of surfactant or surfactants may be utilized for such a treatment composition, preferably the surfactant is fluorinated in nature. It has been found that such fluorinated surfactants permit effective contact, as noted above, between antimicrobial and fiber, and also appears to provide a certain degree of water- and/or other liquid-repellency for the treated fibers. Thus, of particular, non-limiting use are those fluorinated surfactants available from DuPont under the ZONYL® tradename, or other types of fluorinated surfactants such as those available from 3M. The surfactant should be present in an amount of between 0.001 to 25% by weight of the total treatment composition; more preferably from about 0.01 to about 10%. The surfactant may also aid in effectuating a dispersion of the solid antimicrobial within the liquid medium (or vehicle); however, some surfactants may either not be present in high enough proportions to provide such effectiveness or simply do not include pendant groups that permit proper intermixing for such dispersions to be long-lasting. Thus, the treatment composition may either be ready-to-use or may require mixing or shaking to effectively bring the proper amounts of desired solid antimicrobials to the area within the dispersion that is to applied (either by spraying, coating, atomizing, or the like). Furthermore, the surfactants themselves may effectuate a suspension within the liquid medium (or vehicle). The dispersion, suspension, or mere liquid composition may further include other additives, such as viscosity modifiers, antistatic agents, etc., in order to either provide desirable properties for application purposes or further finishes or properties to the treated fibers.

Alternatively, or in addition to such a surfactant component, a fumed silica dispersion may be utilized in a liquid treatment composition. Such a silica has been found to provide similar ability to increase contact between the solid antimicrobial and the target fibers, while also providing a certain degree of anti-soil redeposition properties. The fumed silica and solid antimicrobial can thus be applied simultaneously within such a dispersion for increased antimicrobial and anti-soil redeposition purposes. In such a situation, the fumed silica can be present in an amount of between about 0.1 to about 35% by weight of the total treatment composition. As above, further additives (viscosity modifiers, etc.) may be present. In addition, the fumed silica/solid antimicrobial liquid composition may be in dispersion form (particularly if a surfactant is also present), suspension form, or mere liquid form, as above as well.

It is potentially preferred, though not required, that the liquid form of the treatment composition be a shampoo for application to target floor covering articles. Thus, the surfactant or surfactants within such a liquid composition generate froth, foam, and/or suds in which the solid antimicrobial is present as well when contacted with the target surface. Such a shampoo thus permits excellent penetration of both the cleaning and/or treating surfactant components as well as the solid antimicrobial compounds to facilitate the above-discussed embedding of the solid compounds within the target fibers. Within such a potentially preferred carpet shampoo composition, the surfactants are preferably anionic in nature (such as sodium long-chain fatty acid salts, sodium lauryl sulfate, as one particular non-limiting example), although fluorinated surfactants may also be added in order to impart the above-described properties to the target fibers as well. Such a shampoo may be applied as an aerosol (with typical propellants present), or as a viscous liquid which, upon agitation on and within the target floor covering article, generates the needed foam, froth, and/or suds for implementation of such a cleaning/disinfecting shampoo composition. The shampoo may also include, as noted above, a solvent for the surfactant components, such as water, short-chain alcohols, and the like, that are typical within such carpet shampoo compositions. Generally, the amount of surfactant in such a composition should be from about 0.1 to about 50% by weight of the total composition; more preferably from about 0.5 to about 30%; and most preferably between about 1.0 and 15%.

Solid forms of the inventive treatment compositions include a mixture of the fumed silica with the solid antimicrobial, or, more preferably, the combination of the solid antimicrobial with a urea-formaldehyde polymeric powder (available, as one example, under the tradename CAPTURE® from Milliken & Company. In such situations, the fumed silica or the CAPTURE® powder constitute the great majority of the mixture, at least 95% by weight thereof. Either type mixture may be applied either in completely dry form or after a pre-wet of the target fibers. In any event, the solid compositions aid in either preventing soil redeposition (fumed silica) or in attracting soil and other particles into the powder which can then be vacuumed from the pile fibers, leaving a cleaner floor covering article than before (CAPTURE®). In such situations, the solid antimicrobial appears not to be attracted to the urea-formaldehyde polymer as much as it is drawn to and embedded within the target fibers (particularly synthetic fibers), which is highly surprising. Furthermore, as noted below, without applying any further antimicrobial treatments to target fibers, even after a certain duration of time, the applied solid antimicrobials will show increased efficacy for the pile surfaces of the target floor covering article after mere vacuuming. Again, such a result is highly surprising, but, without intending to be limited to any scientific theory, it is believed that such a result is due to the possible presence of solid antimicrobial compounds at the bottom of the fiber portion of the floor covering article itself and the movement, via vacuuming, of such compounds to a location closer to the surface thereof without completely being lost into the vacuum.

The term floor covering, as noted above, is intended to cover any standard articles which comprise face fibers and which are utilized to cover surfaces on which people are prone to walk. Thus, carpets (broadloom, tile, or otherwise) and floor mats (outdoor, indoor, and the like) are the primary articles concerned within this invention. The term face fiber portion encompasses any standard fibers and composites thereof, which are utilized within floor coverings. As mere examples, nylon, polyethylene, polypropylene, cotton, polyvinylacetate, and the like, fibers may be tufted through a fabric (such as a woven, non-woven, or knit fabric of any fiber type, such as those listed previously), which happens to be what is intended to be encompassed by the term primary backing portion. Also, the face fiber portion may be monofilament, core-sheath fiber, and the like, or may be present as berber or any other type of carpet face.

Initially, prior to integration with any other components, with regard to carpet products, the face fiber portion is sewn, tufted, needled, and the like, through the primary backing fabric to form a composite which can then be simply adhered to a further portion. Alternatively, the primary backing fabric may be contacted with the secondary backing fabric and the face fiber portion may then be created by the needling, etc., through the primary backing fabric. Basically, any number of alternatives are available for production of the inventive floor covering product. Examples of carpet and carpet tile production are disclosed within U.S. Pat. No. 5,929,145 to Higgins et al., U.S. Pat. No. 5,948,500 to Higgins et al., U.S. Pat. No. 5,545,276 to Higgins et al., and U.S. Pat. No. 5,540,968 to Higgins et al. Examples of floor mat production are present within U.S. Pat. No. 5,902,662 to Kerr, U.S. Pat. No. 5,928,446 to Kerr et al., and U.S. Pat. No. 5,305,565 to Nagahama et al. Preferably, a latex is utilized to adhere the face fiber portion to a secondary backing to form a stabilized composite. The latex may include an antimicrobial if desired as well.

The term secondary backing portion is intended to be rather broad since the important issue with regard to such a component is the contact with the inventive latex between that layer and the primary backing fabric. Such a secondary layer then may be of any standard carpet or floor mat backing, or intermediate layer. Thus, if it is a carpet, the secondary backing may be a polyolefin fabric, or a polyurethane foam (for cushioning purposes) or simply a fabric layer to which a polyurethane foam is attached. If it is a floor mat, the secondary backing may be a sheet of solid or foamed rubber most likely, although, again, such a backing may be an intermediate layer of fabric, rubber, and the like, between the primary backing fabric and an outer layer.

The particular solid metal-ion-based antimicrobial agent should exhibit an acceptable log kill rate after 24 hours in accordance with the AATCC Test Method 100-1999. Such an acceptable level log kill rate is tested for Staphylococcus aureus of at least 0.1 increase over baseline. Alternatively, an acceptable level will exist if the log kill rate is greater than the log kill rate for non-treated (i.e., no solid inorganic antimicrobial added) pile fibers (such as about 0.5 log kill rate increase over control, antimicrobial-free fibers). Preferably this log kill rate baseline increase is at least 0.3 for S. aureus; more preferably 0.5; and most preferably 1.0. Of course, the high end of such log kill rates are much higher than the baseline, on the magnitude of 5.0 (99.999% kill rate). Any rate in between is thus, of course, acceptable as well. However, log kill rates which are negative in number are also acceptable for this invention as long as such measurements are better than that recorded for correlated non-treated fibers. In such an instance, the antimicrobial material present within the target carpet pile fibers at least exhibits a hindrance to microbe growth.

The preferred embodiments of these alternatives fiber treatments are discussed in greater detail below.

### DESCRIPTION OF THE PREFERRED EMBODIMENTS

Examples of particularly preferred treatments within the scope of the present invention are set forth below.

Liquid Treatment Compositions

The preferred antimicrobial-containing treatment formulations were compounded in accordance with the Table below with all of the components admixed together. The manufacturing during which topical treatment was undertaken with such specific formulations are noted below in the Table as well.

### EXAMPLE 1

### Anionic Surfactant-Containing Shampoo Composition

| Component | Amount added (% by weight) |
|---|---|
| Sodium Lauryl Sulfate | 1 |
| Water | balance |
| Antimicrobial | (as listed below) |

### EXAMPLE 2

### Fluorinated Surfactant-Containing Spray Composition

| Component | Amount added (% by weight) |
|---|---|
| ZONYL ® 8300 | 10 |
| Water | Balance |
| Antimicrobial | (as listed below) |

Solid Treatment Compositions

The preferred antimicrobial-containing treatment formulations were compounded in accordance with the Table below with all of the components admixed together. The manufacturing during which topical treatment was undertaken with such specific formulations are noted below in the Table as well.

### EXAMPLE 3

### Urea-Formaldehyde Mix

| Component | Amount added (% by weight) |
|---|---|
| CAPTURE ®-brand powder | 98 |
| Antimicrobial | 2 |

### EXAMPLE 4

### Silica Mix

| Component | Amount added (% by weight) |
|---|---|
| Silica (Aerosil 130) | 50 |
| Antimicrobial | 50 |

### EXAMPLE 5

### Urea-Formaldehyde/Silica Mix

| Component | Amount added (% by weight) |
|---|---|
| CAPTURE ®-brand powder | 96 |
| Silica (Aerosil 130) | 2 |
| Antimicrobial | 2 |

A further Example 6 entailed merely brushing in the antimicrobial (in such an instance ALPHASAN® RC5000 in an amount to impart 11,600 ppm addition to the target floor covering sample (nylon carpet tile). Control treatments were also applied utilizing no antimicrobial compounds at all.

The above liquid and solid treatment compositions were then individually applied to typical cushioned carpet tile articles produced in accordance with the general manufacturing processes of U.S. Pat. Nos. 5,540,968 and 5,545,276 and tested for antimicrobial efficacy initially, after subsequent shampooing under AATCC Test Method 138, and after subsequent vacuuming without any further antimicrobial compounds applied thereto.

The amount of antimicrobial applied to the target carpet tile pile portion was adjusted to uniformly equal different levels, from 500 ppm on the weight of the face fiber (owff) up to 11,600 owff (to test the difference between efficacy at such disparate antimicrobial levels as well as to compensate for expected amounts removed during post-treatment vacuuming steps). The log kill results were as follows for K. pneumoniae after 24 hours of exposure, initially and after 2 subsequent shampoo treatments in accordance with AATCC Test Method 138:

EXPERIMENTAL DATA TABLE 1
Log Kill Rates for K. pneumoniae on
Polyester Carpet Tile Samples

| | | | Log |
|---|---|---|---|
| | | Initial or | Kill |
| | Antimicrobial (ppm owff) | Vacuumed | Rate |
| Ex. # | | | |
| (above) | | | |
| 1 | ALPHASAN ® RC 5000 (11,600) | Initial | 1.17 |
| 1 | ALPHASAN ® RC 5000 (11,600) | Vacuumed | 2.15 |
| (Comparative | | | |
| Examples) | | | |
| 1 | None | Initial | −0.26 |
| 1 | None | Vacuumed | −0.20 |
| Control | None | Initial | −0.68 |

EXPERIMENTAL DATA TABLE 2
Log Kill Rates for K. pneumoniae on
Nylon Carpet Tile Samples

| | | Initial, | |
|---|---|---|---|
| | | Shampooed*, | |
| | | | Log |
| | | or | Kill |
| | Antimicrobial Type (ppm owff) | Vacuumed | Rate |
| Ex. # | | | |
| (above) | | | |
| 2 | ALPHASAN ® RC 5000 (500) | Initial | 1.53 |
| 2 | ALPHASAN ® RC 5000 (500) | Shampooed | 1.27 |
| 2 | ALPHASAN ® RC 5000 (2000) | Initial | 2.34 |
| 2 | ALPHASAN ® RC 5000 (2000) | Shampooed | 2.22 |
| 3 | ALPHASAN ® RC 5000 (11,600) | Initial | 2.00 |
| 4 | ALPHASAN ® RC 5000 (11,600) | Initial | 3.28 |
| 5 | ALPHASAN ® RC 5000 (11,600) | Initial | 2.49 |
| 5 | ALPHASAN ® RC 5000 (11,600) | Vacuumed | 3.41 |
| 6 | ALPHASAN ® RC 5000 (11,600) | Initial | 1.56 |
| 6 | ALPHASAN ® RC 5000 (11,600) | Vacuumed | 3.74 |
| (Comparative | | | |
| Examples) | | | |
| 2 | None | Initial | 0.17 |

*Two shampooings were undertaken in accordance with AATCC Test Method 138

Thus, the inventive methods as well as invnetive antimicrobial treatment compositions imparted excellent durable antimicrobial properties to the target floor covering articles.

There are, of course, many alternative embodiments and modifications of the present invention which are intended to be included within the spirit and scope of the following claims.

What we claim is:

1. A method of topically applying an antimicrobial treatment to a floor covering article comprising the steps of
(a) providing a solid or liquid treatment composition comprising a solid antimicrobial and at least one other compound selected from the group consisting of a surfactant, a urea-formaldehyde-containing powder, fumed silica, a fluorinated polymer, and any mixture thereof;
(b) providing a floor covering article; and
(c) contacting said treatment composition of step “a” with said floor covering article of step “b”;
wherein said treatment composition imparts an antimicrobial level to said floor covering article measured as a log kill rate for Klebsiella pneumoniae of at least 1.0.

2. The method of claim 1 wherein said at least one solid antimicrobial is a metal-ion containing antimicrobial agent.

3. The method of claim 2 wherein said metal-ion containing antimicrobial agent is a silver-ion based compound.

4. The method of claim 3 wherein said silver-ion based compound is a silver ion-exchange compound.

5. The method of claim 1 wherein said treatment composition is a liquid.

6. The method of claim 5 wherein said liquid is a shampoo.

7. The method of claim 5 wherein said liquid comprises an anionic surfactant.

8. The method of claim 1 wherein said treatment composition is a solid.

9. The method of claim 8 wherein said solid is a fumed silica/solid antimicrobial mix.

10. The method of claim 8 wherein said solid is a urea-formaldehyde polymer/solid antimicrobial mix.

11. The method of claim 5 wherein said liquid is a spray.

12. The method of claim 11 wherein said liquid comprises a fluorinated surfactant.

13. A solid antimicrobial floor covering treatment composition comprising at least one component selected from the group consisting of a urea-formaldehyde polymer, a fumed silica, and any mixtures thereof, and at least one solid antimicrobial compound.

14. The composition of claim 14 wherein said at least one solid antimicrobial is a metal-ion containing antimicrobial agent.

15. The composition of claim 14 wherein said metal-ion containing antimicrobial agent is a silver-ion based compound.

16. The composition of claim 15 wherein said silver-ion based compound is a silver ion-exchange compound.

17. A method of topically applying an antimicrobial treatment to a floor covering article comprising the steps of
(a) providing a solid antimicrobial composition comprising at least one silver-based ion-exchange compound;
(b) providing a floor covering article; and
(c) contacting said treatment composition of step “a” with said floor covering article of step “b”;
wherein said treatment composition imparts an antimicrobial level to said floor covering article measured as a log kill rate for Klebsiella pneumoniae of at least 1.0.

18. A carpeted article exhibiting an initial antimicrobial level, measured as a log kill rate for Klebsiella pneumoniae of a first level; wherein said carpeted article exhibits an increase in the log kill rate for Klebsiella pneumoniae as compared with said initial antimicrobial level after said carpeted article is subjected to a vacuuming treatment without any additional antimicrobial compounds added after said initial antimicrobial level is measured.
